(19) United States
(12) Patent Application Publication
(10) Pub. No.: US 2019/0005009 A1
(43) Pub. Date: Jan. 3, 2019

(54) CUSTOMIZED VERSION LABELING FOR ELECTRONIC DOCUMENTS

(71) Applicant: Microsoft Technology Licensing, LLC, Redmond, WA (US)

(72) Inventors: John Lincoln DeMaris, Seattle, WA (US); Carlos Perez, Seattle, WA (US); Melissa Torres, Kirkland, WA (US)

(21) Appl. No.: 15/638,129

(22) Filed: Jun. 29, 2017

(51) Int. Cl. G06F 17/22; G06F 17/30

(52) U.S. Cl. CPC G06F 17/2288; G06F 17/30011

(57) ABSTRACT

Among other things, embodiments of the present disclosure help improve the functionality of electronic document management software and systems by generating customized descriptive version labels for electronic documents based on actions and events involving the document. In various embodiments, the system may determine and apply version labeling based on a file being shared, opened, presented, copied, or based on other actions and events.

### BACKGROUND

Document management systems allow users to create, edit, and share electronic documents. Some document management systems may contain different versions of a particular document, presenting challenges to users seeking to understand the significance of a particular document version or find a document version associated with a particular event or action. Embodiments of the present disclosure address these and other issues.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating an example of a system according to various aspects of the disclosure;

FIG. 2 illustrates a flowchart of an example of a method according to various aspects of the disclosure;

FIGS. 3, 4A, 4B, 5A, and 5B are examples of screenshots according to various aspects of the disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Among other things, embodiments of the present disclosure help improve the functionality of electronic document management software and systems by generating customized descriptive version labels for electronic documents based on actions and events involving the document. In various embodiments, the system may determine and apply version labeling based on a file being shared, opened, presented, copied, or based on other actions and events. This version labeling may result from explicit versioning (e.g., versioning resulting from a user interaction and user application of a label), or implicit versioning (e.g., versioning resulting as a result of activities, such as sharing, access, viewing, or editing among multiple users).

Embodiments of the present disclosure described herein may be implemented using any combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Embodiments of the present disclosure may include, or may operate in conjunction with, various logic, components, modules, and mechanisms. Such components may include any combination of hardware, software, or firmware communicatively coupled to one or more processors in order to carry out the operations described herein. Components may be hardware components, and as such components may be considered tangible entities capable of performing specified operations and may be configured or arranged in a certain manner. For example, circuits may be arranged (e.g., internally or with respect to external entities such as other circuits) in a specified manner as a component. The whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine-readable medium.

In some embodiments, software, when executed by the underlying hardware of the component, causes the hardware to perform the specified operations. Accordingly, the term hardware component is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the modules need not be instantiated at any one moment in time. For example, where the components comprise a general-purpose hardware processor configured using software; the general-purpose hardware processor may be configured as respective different components at different times. Software may accordingly configure a hardware processor, for example, to constitute a particular component at one instance of time and to constitute a different component at a different instance of time. Components may also be software or firmware components, which operate to perform the methodologies described herein.

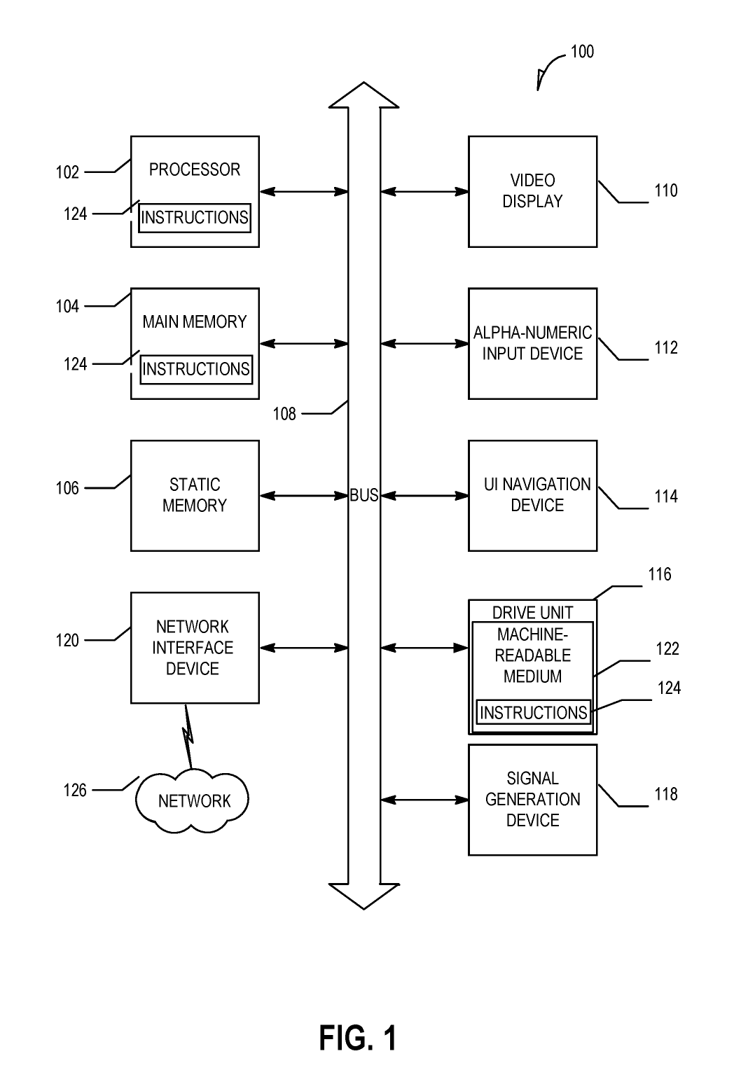

FIG. 1 is a block diagram illustrating an embodiment of a computer system 100, within which a set or sequence of instructions may be executed to cause the system to perform any of the functionality discussed herein. In some embodiments, the system 100 may operate as a standalone device or may be connected (e.g., networked) to other machines. In a networked deployment, the system may operate in the capacity of either a server or a client system in server-client network environments, or it may act as a peer machine in peer-to-peer (or distributed) network environments. The system may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine.

While only a single computer system is illustrated in FIG. 1, the terms “system,” “machine,” or “device” may include any collection of systems, machines, or devices that individually or jointly perform various functionality of the embodiments of the present disclosure. Similarly, the term “processor-based system” may include any set of one or more machines that are controlled by or operated by a processor (e.g., a computer) to individually or jointly execute instructions to perform any one or more of the methodologies discussed herein.

The computer system 100 in FIG. 1 includes a processor 102 (e.g., a central processing unit (CPU), a graphics processing unit (GPU) or both, processor cores, compute nodes, etc.), a main memory 104 and a static memory 106, which communicate with each other via a link 108 (e.g., bus). The computer system 100 may further include a video display unit 110, an alphanumeric input device 112 (e.g., a keyboard), and a user interface (UI) navigation device 114 (e.g., a mouse). In one embodiment, the video display unit 110, input device 112 and UI navigation device 114 are incorporated into a touch screen display. The computer system 100 may additionally include a storage device 116 (e.g., a drive unit), a signal generation device 118 (e.g., a speaker), a network interface device 120, and one or more sensors (not shown), such as a global positioning system (GPS) sensor, compass, accelerometer, or other sensor.

The storage device 116 includes a machine-readable medium 122 on which is stored one or more sets of data structures and instructions 124 (e.g., software) embodying or utilized by any one or more of the methodologies or functions described herein. The instructions 124 may also reside, completely or at least partially, within the main memory 104, static memory 106, and/or within the processor 102 during execution thereof by the computer system 100, with the main memory 104, static memory 106, and the processor 102 also constituting machine-readable media.

While the machine-readable medium 122 is illustrated to be a single medium, the term “machine-readable medium” may include a single medium or multiple media (e.g., a centralized or distributed database, and/or associated caches and servers) that store the one or more instructions 124. The term “machine-readable medium” may include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” may include, for example, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 124 may be transmitted or received over a communications network 126 using a transmission medium via the network interface device 120 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

In various embodiments of the present disclosure, techniques are disclosed for labeling particular versions of files, content items, or other forms of data, based on the corresponding lifecycle events involved with such data items. For instance, the techniques discussed herein allow direct lifecycle events to be recorded and performed on particular versions of files, through forms of explicit or implicit labeling. In contrast, the use of labels in existing content management systems and file systems is a manual process that often involves creating and tracking distinct copies of the file.

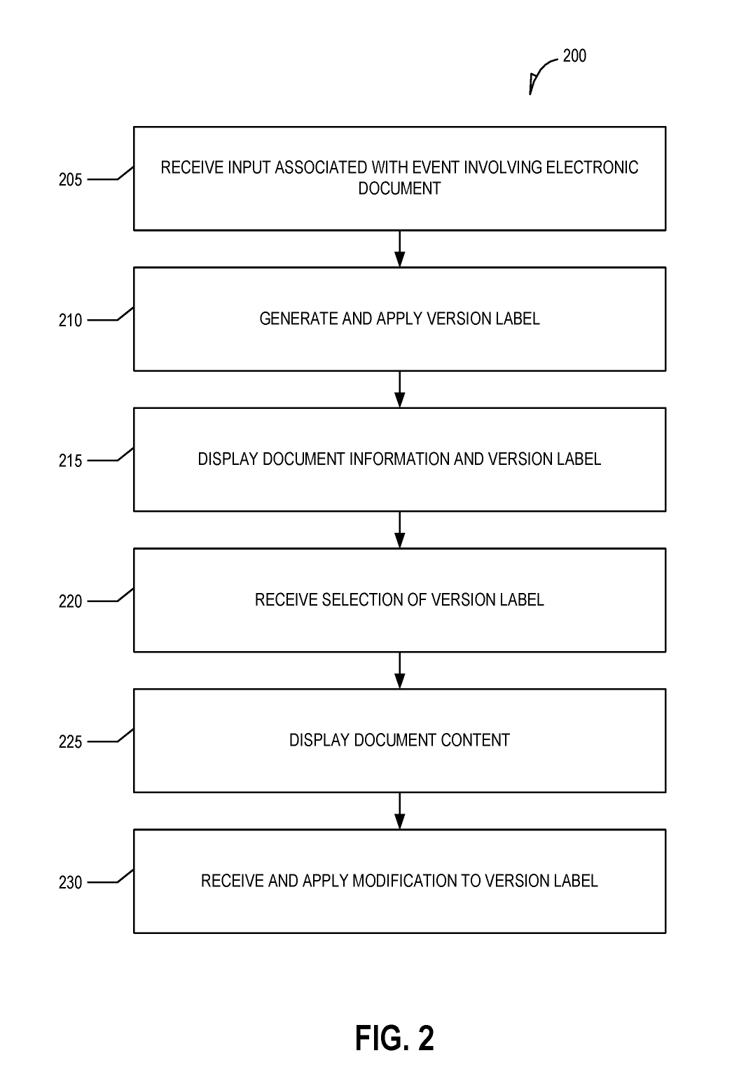

FIG. 2 depicts an example of a process according to various aspects of the present disclosure. In this example, method 200 includes receiving input associated with an event involving an electronic document (205), generating and applying a version label to the electronic document (210), displaying information regarding the document with the version label (215), receiving a selection of the version label (220), displaying document content (225), and receiving and applying a modification to the version label (230). The steps of method 200 may be performed in whole or in part, may be performed in conjunction each other as well as with some or all of the steps in other methods, and may be performed by any number of different systems, such as the system described in FIG. 1.

Embodiments of the present disclosure may receive (205) a variety of inputs associated with documents in a document management system. The document management system (e.g., Sharepoint by Microsoft Corporation, or OneDrive by Microsoft Corporation) may be implemented by the system (in whole or in part) by the system(s) performing the functionality of method 200, as well as by any combination of other systems and devices (e.g., in communication with each other via a network such as the Internet). Embodiments of the present disclosure may also operate in conjunction with content published by other types of software applications and systems, such as content management systems, social media platform systems, and the like.

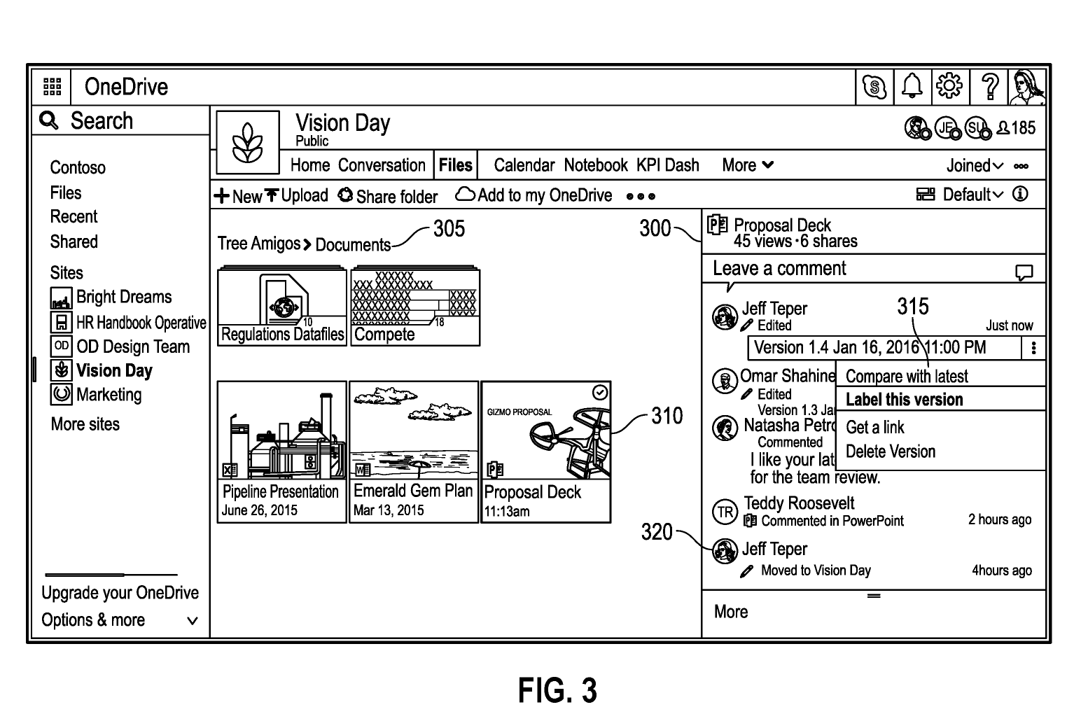

FIG. 3 is an example of a screenshot of an interface provided by the system to users. In this example, the system displays a list of documents 305 from the selected “Vision Day” site in the left column. This example displays the “Proposal Deck” document 310 selected, with a history 300 of version labels and events in the right column. In this example, a menu 315 listing a set of actions is presented with the “label this version” option currently selected. Version labels describing actions involving the document, such as the “Moved to Vision Day” 320 version, are listed in the history 300.

In the example depicted in FIG. 3, the “Proposal Deck” document is part of a collaborative repository where multiple individuals (e.g., Jeff Teper, Omar Shahine, etc.) have access to, and work on files together. For example, teams of software engineers commonly work on files together (e.g., adding functions, data, and code) in order to produce a final software release. In conventional systems, document versions are typically assigned a numeric value. As contributors make changes to a file, the numeric value of the version number may be automatically incremented (e.g., version 1.01 goes to 1.02, and so forth). However, these numbers generally have no semantic meaning, and users often cannot tell, simply by looking at the version label, what actions or events are associated with the new version.

For example, in a conventional system a user may work on a file in preparation for an executive review with his or her team, and access a file with version number 0.234 at the time of the executive review. The user presents the file at the review, and later incorporates changes to the file based on feedback from the review. Because incorporating those changes involves multiple file saves, the file advances to version 0.245. However, the user has no way of remembering that 0.234 was the version of the file that the user presented at the meeting, even though that history and context is meaningful.

In some embodiments, the input associated with an event involving an electronic document may include an explicit input from the user to define a version label. Referring again to FIG. 3, for example, the user can select the pull-down menu 315 and pick the “label this version” option, which allows a user to type in a version label (or modify the existing label). Subsequently, that label is seen next to the corresponding number in the version history UI 300, so that it can be easily found again.

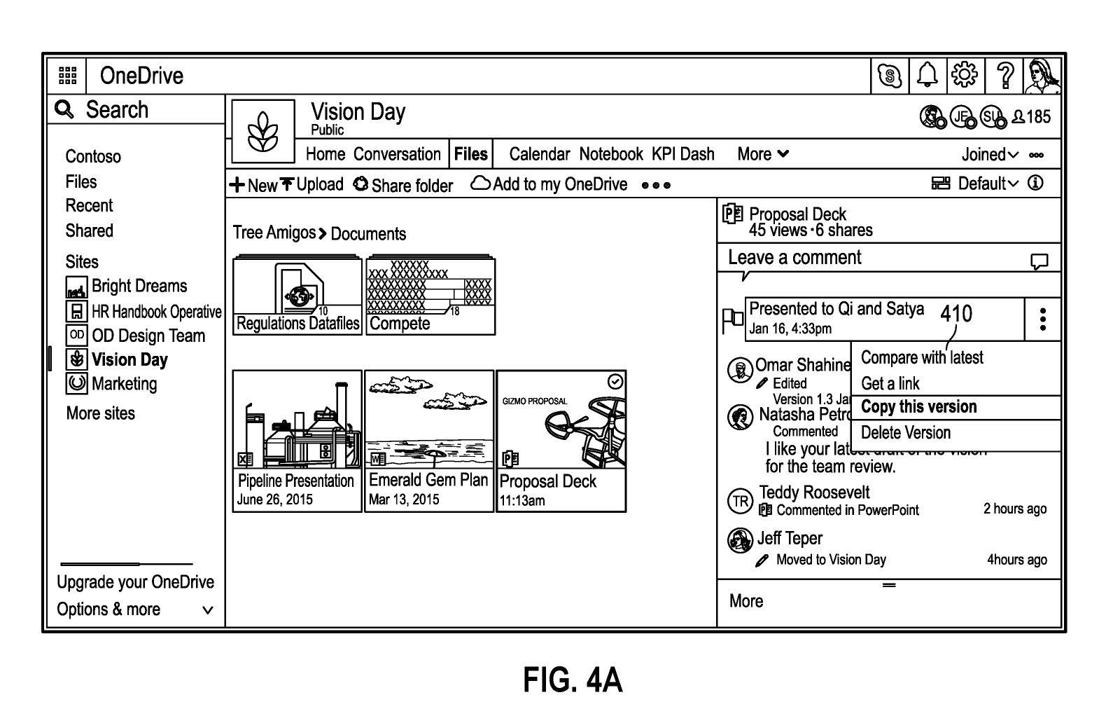

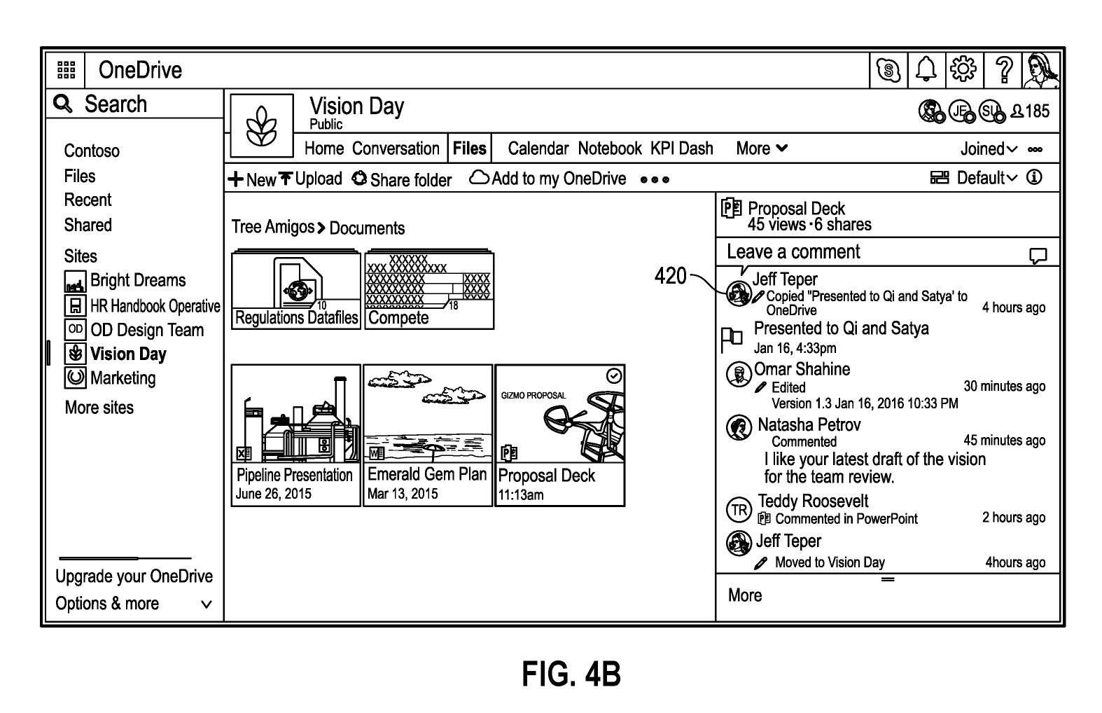

Embodiments of the present disclosure may also generate and apply (210) a version label to an instance of the document based on the input from the user and/or the event involving the electronic document. In FIG. 4A, for example, the user has selected the “Copy this version” option from the menu 410 associated with a version of the “Proposal Deck” document currently labeled “Presented to Qi and Satya January 16, 4:33 pm.” The system receives (205) the input associated with the copy action, performs the copy, and generates and applies (210) a new version label 420 to a new instance of the document that describes the copy action. Information regarding the document (i.e., the document's name and an icon associated with the document in this example) is displayed on the screen along with the version label(s), as shown FIG. 4B. A user may thus make subsequent edits to either the instance, with such edits likewise being reflected in the history of the document. In this manner, the system allows versions of a document to “branch” such that different instances can exist simultaneously, while providing an intuitive and descriptive version label for each action involving the different instances of the document.

Embodiments of the present disclosure may automatically generate and apply (210) version labels based on some or all of the actions/events that involve a file. For example, a new label may be created any time a file is shared, opened, edited, moved, copied, deleted, or presented. In some embodiments, users (such as an administrator for a project or the system) may provide the system with criteria for generating and applying (210) labels, such as restricting labels to actions that change the content of a file (e.g., writes or edits) but not creating a new version label every time someone simply opens the file. In this manner, the system can allow users to define the actions that are important and thus require labeling, while excluding extraneous and distracting labeling from events that are trivial.

The system may apply any number of version labels to instances of a document. In this context, different “instances” of a document refers to there being different distinct copies (and possibly chains of edits) between one version of a document and another version of a document. For example, the first version label in the document version history 300 in FIG. 3 indicates that Jeff Teper performed a move action on the document to the “Vision Day” site currently viewed by the user. In this example, a user may select the “Moved to Vision Day” version label and examine the content of the “Proposal Deck” document instance associated with that label. By contrast, the top version label in history 300 is labeled “Version 1.4” and indicates Jeff Teper edited the document. This second version label may be created in response to receiving a second input associated with a second event, namely Jeff Teper opening and editing the document, and then saving the changes. The second instance associated with this version (version 1.4) of the document may thus have different content than the instance of the document associated with the “Moved to Vision Day” version label. Information for the document (e.g., the document's name and icon in the middle window) is thus displayed in conjunction with the first and second version labels in history 300.

In some cases, the system may infer an “important” action or event that warrants a version label based on a number of users viewing or accessing a file. For example, the system may identify a plurality of users viewing a particular instance of the document at the same time, and depending on the types of events in the application suite that are logged (e.g., selected by an administrator) the system may also determine (e.g., based on accessing the calendars of the users) that at least a portion of the plurality of users were in a meeting together (e.g., an online teleconference session). Accordingly, even though no user explicitly told the system the file was shared during the meeting, the system may determine that the file was presented and generate and apply (210) a version label descriptive of the event, such as: “Presented on Friday March 24th.” Additionally or alternative to the date when the document was presented, the system may include identification information for an entity (e.g., a name of a user or names of a group of users) to whom the document was presented.

The system may allow users to revert a file to a previous version, based on a version label. For example, in many projects (such as software development), users frequently need to go back and reference a previous version of a file, or restore that version and make it the current working version. In conventional versioning systems, users must navigate version numbers and timestamps to find the one they need, which can take considerable time and effort. Users have to frequently open up multiple historical versions until they finally find the one they need, because a timestamp and a version number don't really describe what's in the file. In embodiments of the present disclosure, by contrast, the descriptive and semantically meaningful version labels generated by the system makes the task of finding a particular file version much easier.

In the case of a user performing a copy action on a file, a user may select a file (e.g., the “Proposal Deck” file in FIG. 4A) and then select the “copy” command from the menu 410. The user may select the destination for the copy operation, as well as being provided an option to select a particular version label to copy. In some embodiments, the copy operation may act on the most recent version of the file, but users may also selectively copy a previous instance of the file. The system may generate and apply a version label (210) implicitly to an instance of a document, such as the version label 420 in FIG. 4B, describing the version that was copied, the destination to which it was copied, and the time when it was copied.

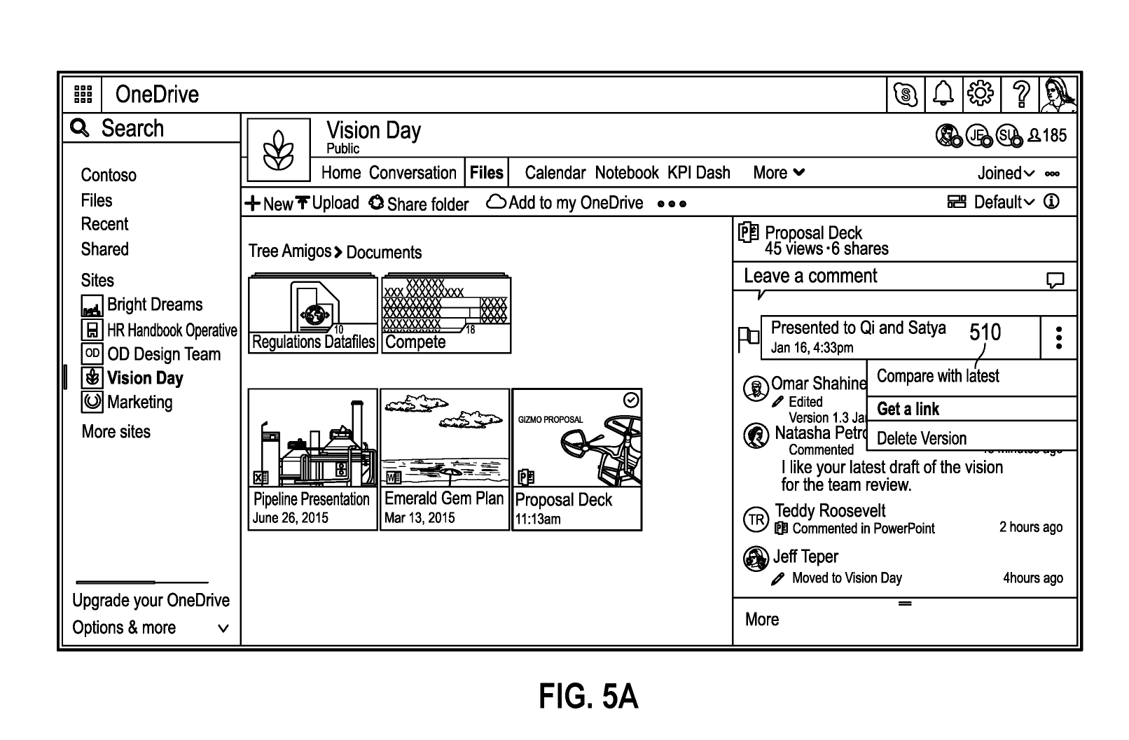

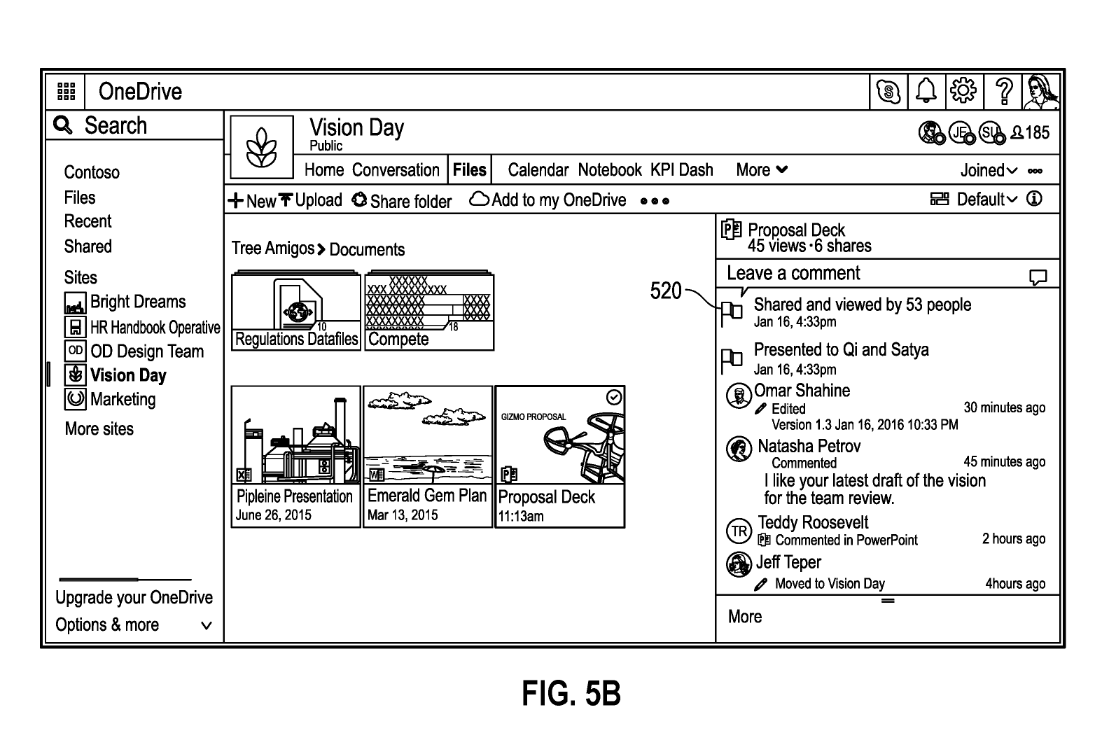

A user may also perform a sharing action associated with an instance of a document. Similar to copying a file, the system may, in response to a share event, generate and apply an implicit version label. This form of an implicit version label may be a contextually simple label such as “Shared with Alice, Bob, and Charlie”. In FIG. 5A, for example, the system receives input from a user selecting the “Get a link” option from menu 510 for a version of the “Proposal Deck” document. The system shares the document with the users identified by the selecting user, and (as shown in FIG. 5B) generates and applies a version label 520 to the document showing when the document was shared and the number of users with whom the document was shared. In other embodiments, the system may list identification information for the entities (e.g., names of users or groups of users) with whom the document was shared (or such information could be displayed in response to selecting the version label).

In various embodiments, the application of an implicit version label may automatically result from actions on and around files that happen to that file at a particular point in time, on a particular version of a file. For example, such implicit version labels may be evaluated every time that a file is shared, opened, or even presented in a meeting, which occurs on the most recent version of a file. In particular, certain versions that are “important” are likely have a natural cluster of activities that happen to those files at the corresponding point in time. In various embodiments, the system may receive a selection (220) of a particular version label from the history 300 and provide options associated with the version label (e.g., menus 315, 410, and 510 discussed above) as well as displaying content (225) of the document instance associated with the selected version label. In various embodiments, the system may compare different versions of a document and display the differences. For example, selection of the option “Compare with latest” in menu 315 of FIG. 3 displays the differences between the selected version label and the latest version label in the history 300. Accordingly, the input from a user associated with an action (e.g., opening, copying, moving, etc.) may include a selection of an existing version label displayed on the display screen, and a version label generated in response to such an action may be applied to an instance of the document that is based on an instance of the document associated with the existing version label.

As noted above, users of the system may manually enter their own version labeling (e.g., at the time the new version is created). Additionally or alternatively, the system may receive and apply a modification (230) to a version label. For instance, a user may select the “Label this version” option from menu 315 in FIG. 3 to add to, remove from, or overwrite, the current version label. In various embodiments, the modification or deletion of an existing version label may in of itself be identified by the system and used to generate and apply a new version label (e.g., “version label changed from ‘alpha’ to ‘beta’ by Bob on May 4”).

Changes and modifications may be made to the disclosed embodiments without departing from the scope of the present disclosure. These and other changes or modifications are intended to be included within the scope of the present disclosure, as expressed in the following claims.

1. A system comprising:
a processor;
a user interface device coupled to the processor, the user interface device including a display screen and an input device; and
memory coupled to the processor and storing instructions that, when executed by the processor, cause the system to perform operations comprising:
receiving, from a user of the system via the input device, an input associated with an action involving an electronic document stored in an electronic document management system;
determining a type of action involving the electronic document;
in response to receiving the input associated with the action, generating a version label based on the type of action, the version label including a description of the action;
applying the version label to an instance of the electronic document in the document management system; and
displaying, on the display screen, information regarding the instance of the document in conjunction with the version label.

2. The system of claim 1, wherein the memory further stores instructions that cause the system to perform operations comprising:
receiving, from the user of the system via the input device, an input associated with a second action involving the electronic document stored in the electronic document management system;
in response to receiving the input associated with the second action, generating a second version label associated with the second action, the second version label having a description of the second action;
applying the second version label to a second instance of the electronic document in the document management system; and
displaying, on the display screen, information regarding the second instance of the document in conjunction with the second version label.

3. The system of claim 2, wherein the system displays, on the display screen, a history of version labels for the electronic document, the history including the version label and the second version label.

4. The system of claim 3, wherein the memory further stores instructions that cause the system to perform operations comprising:
receiving, via the input device, a selection of one of: the version label or the second version label; and
displaying, on the display screen, a content of the instance of the electronic document associated with the selected label.

5. The system of claim 1, wherein the memory further stores instructions that cause the system to perform operations comprising:
receiving an input containing a modification to the version label from the user via the input device of the user interface device; and
modifying the version label in accordance with the received modification.

6. The system of claim 1, wherein the action includes one or more of: sharing the electronic document, opening the electronic document, presenting the electronic document, copying the electronic document, moving the electronic document, or deleting the electronic document.

7. The system of claim 6, wherein the action includes presenting the electronic document, and wherein the generated version label includes one or more of: a date when the electronic document was presented, or identification information for an entity to whom the electronic document was presented.

8. The system of claim 6, wherein the action includes copying the electronic document, and wherein the generated version label identifies a destination where the electronic document was copied.

9. The system of claim 6, wherein the input associated with the action includes a selection of an existing version label displayed on the display screen, and wherein the generated version label is applied to an instance of the document that is based on an instance of the document associated with the existing version label.

10. A computer-implemented method comprising:
receiving, by a computer system and from a user of the system via an input device of a user interface device coupled to the computer system, an input associated with an action involving an electronic document stored in an electronic document management system;
determining a type of action involving the electronic document;
in response to receiving the input associated with the action, generating a version label based on the type of action, the version label including a description of the action;
applying, by the computer system, the version label to an instance of the electronic document in the document management system; and
displaying, by the computer system on a display screen of the user interface device, information regarding the instance of the document in conjunction with the version label.

11. The method of claim 10, further comprising:
receiving, by the computer system and from the user of the computer system via the input device, an input associated with a second action involving the electronic document stored in the electronic document management system;
in response to receiving the input associated with the second action, generating, by the computer system, a second version label associated with the second action, the second version label having a description of the second action;
applying, by the computer system, the second version label to a second instance of the electronic document in the document management system; and
displaying, by the computer system on a display screen of the user interface device, information regarding the second instance of the document in conjunction with the second version label.

12. The method of claim 11, wherein the computer system displays, on the display screen, a history of version labels for the electronic document, the history including the version label and the second version label.

13. The method of claim 12, further comprising:
receiving, by the computer system via the input device, a selection of one of: the version label or the second version label; and
displaying, by the computer system on the display screen, a content of the instance of the electronic document associated with the selected label.

14. The method of claim 10, further comprising:
receiving, by the computer system, an input containing a modification to the version label from the user via the input device of the user interface device; and
modifying, by the computer system, the version label in accordance with the received modification.

15. The method of claim 10, wherein the action includes one or more of: sharing the electronic document, opening the electronic document, presenting the electronic document, copying the electronic document, moving the electronic document, and deleting the electronic document.

16. The method of claim 15, wherein the action includes presenting the electronic document, and wherein the generated version label includes one or more of: a date when the electronic document was presented, and identification information for an entity to whom the electronic document was presented.

17. The method of claim 15, wherein the action includes copying the electronic document, and wherein the generated version label identifies a destination where the electronic document was copied.

18. The method of claim 15, wherein the input associated with the action includes a selection of an existing version label displayed on the display screen, and wherein the generated version label is applied to an instance of the document that is based on an instance of the document associated with the existing version label.

19. A non-transitory computer-readable medium storing instructions that, when executed by a computer system, cause the computer system to perform operations comprising:
receiving, from a user of the computer system via an input device of a user interface device coupled to the computer system, an input associated with an action involving an electronic document stored in an electronic document management system;
determining a type of action involving the electronic document;
in response to receiving the input associated with the action, generating a version label based on the type of action, the version label including a description of the action;
applying the version label to an instance of the electronic document in the document management system; and
displaying, on a display screen of the user interface device, information regarding the instance of the document in conjunction with the version label.

20. The non-transitory computer-readable medium of claim 19, wherein the medium further stores instruction for causing the computer system to perform operations comprising:
receiving, from the user of the system via the input device, an input associated with a second action involving the electronic document stored in the electronic document management system;
in response to receiving the input associated with the second action, generating a second version label associated with the second action, the second version label having a description of the second action;
applying the second version label to a second instance of the electronic document in the document management system; and
displaying, on the display screen, information regarding the second instance of the document in conjunction with the second version label.
